(19) United States
(12) Patent Application Publication
(10) Pub. No.: US 2012/0249390 A1
(43) Pub. Date: Oct. 4, 2012

(54) ANTENNA AND WIRELESS DEVICE PROVIDED WITH SAME

(75) Inventors: Yohei Shirakawa, Hitachi (JP); Kazuhiro Fujimoto, Hitachi (JP); Masamichi Kishi, Hitachinaka (JP); Naoto Teraki, Takahagi (JP); Yoshitake Ageishi, Hitachi (JP)

(73) Assignee: Hitachi Cable Fine-Tech, Ltd.

(21) Appl. No.: 13/432,198

(22) Filed: Mar. 28, 2012

(30) Foreign Application Priority Data
Mar. 28, 2011 (JP) 2011-070250

(51) Int. Cl. H01Q 9/06

(52) U.S. Cl. 343/790

(57) ABSTRACT

There is provided an antenna comprising: a ground conductor; and an antenna element portion for sending and receiving electromagnetic wave signals, the antenna element portion comprising: a coaxial cable including a center conductor and an outer conductor; a feeding point connected to a feeding system and disposed between the ground conductor and a first end of one of the center and outer conductors; a short-circuit portion electrically connecting the ground conductor and a first end of the other one of the center and outer conductors; and a conductor connection portion electrically connecting second ends of the center and outer conductors each other. In addition, an overall length of the coaxial cable is not more than ½ of a wavelength corresponding to the minimum series resonance frequency; and a distance between the center and outer conductors is not more than 1/100 of a wavelength corresponding to the minimum operation frequency.

### CLAIM OF PRIORITY

The present application claims priority from Japanese patent application serial no. 2011-070250 filed on Mar. 28, 2011, the content of which is hereby incorporated by reference into this application.

### BACKGROUND OF THE INVENTION

1. Field of the Invention

The present invention relates to antennas and wireless devices provided with the same that are mounted on laptop personal computers, UMPCs (ultra mobile personal computers), netbooks, cellular phones, PNDs (personal navigation devices), sensor network terminals or the like, and that send and receive electromagnetic wave signals.

2. Description of Related Art

A planar multi-band antenna has been proposed as an antenna that is applicable to wireless systems such as WWAN (wireless wide area network), WLAN (wireless local area network), RFID (radio frequency identification), WiMax (worldwide interoperability for microwave access), Blue Tooth, and LTE (long term evolution) and is embedded in wireless communication terminals (wireless devices) that are capable of being used in these systems, such as laptop personal computers (notebook PCs), UMPCs, netbooks, cellular phones, PNDs, sensor networks (see JP-B 3690375, for example).

This planar multi-band antenna is small in size and suitable for being embedded in wireless communication terminals. It is also capable of operating at a plurality of frequency bands used for communications.

FIG. 17 is a schematic diagram showing a plane view of an example of a conventional planar multi-band antenna. As shown in FIG. 17, a planar multi-band antenna 171 is provided with an antenna element portion 172, a ground conductor 173, and a feeding point 174 connected to a feeding system. The antenna element portion 172 is composed of a plurality of rectangular conductors (conductors that are rectangular in a plan view). When embedded in a wireless communication terminal, the planar multi-band antenna 171 is, for example, connected to a wireless communication module that sends and receives high frequency signals via a coaxial cable, a microstrip line path formed on a printed-circuit board, or the like.

Nowadays, small-sized wireless communication terminals, such as laptop PCs, tablet PCs and electronic book readers, send and receive information such as still and video images and music predominantly by using wireless communications systems based on wireless communication standards such as the above-mentioned WLAN, WWAN, and WiMax. These wireless communication terminals are equipped with an antenna compliant with each standard, and information is sent and received via electromagnetic waves sent and received by this antenna.

Meanwhile, the prices of these wireless communication terminals are becoming lower as these terminals become more widely available, resulting in a greater need for lower-priced antennas to be embedded in those terminals.

Since the conventional planar multi-band antenna 171 is adaptable to the above-mentioned wireless communication standards and small in size, it may be said that it is suitable for being embedded in small-sized wireless communication terminals. In order to achieve cost reduction, however, it is necessary to reduce a thickness of the conductor plates and change materials from which the conductor plates are made. Unfortunately, the thickness of and materials for the conductor plates required to keep the antenna performance at a desired standard are predetermined to some degree, and so there are limitations to cost reduction.

Also, nowadays the above-mentioned wireless communication terminals are required to be small so that they are easy to carry and to have an outer configuration with no projections or depressions. In addition, an antenna embedded in a wireless communication terminal is often disposed near free space, more specifically, near a wall of the enclosure to maintain good radiation characteristics of the antenna, which means that the size and the outer configuration of the antenna significantly affects an outer configuration of the wireless communication terminal.

In the conventional planar multi-band antenna 171, the antenna element portion 172 is composed of a plurality of rectangular conductors that are located (pile) on top of each other in the vertical direction in the figure with respect to the ground conductor 173. As a result, a height of the antenna, namely, the distance between the top end of the ground conductor 173 and the top most end of the antenna element portion 172 that is the farthest away from the ground conductor 173 becomes large.

A wireless communication terminal whose antenna is large in height has more projections and depressions in configuration, which poses a problem that the terminal is not easy to carry. Also, if such a wireless communication terminal were to have a smooth outer configuration, it would have to be larger in size.

Meanwhile, if the rectangular conductors of the antenna element portion 172 were disposed closer to the ground conductor 173 so that the height of the antenna becomes smaller, the number of frequency bands at which the antenna is capable of operating would decrease, thereby posing another problem that the terminal becomes incapable of operating at desired frequency bands. Moreover, in the conventional planar multi-band antenna 171, the antenna element portion 172 that sends and receives electromagnetic wave signals is fixed in configuration, resulting in limited freedom to design the portion where the antenna is located.

### SUMMARY OF THE INVENTION

In view of the foregoing, it is an objective of the present invention to solve the above-described problems and provide a low-profile, small-sized, inexpensive antenna that is capable of operating at frequency bands equivalent to those at which conventional antennas are capable of operating and that extends the freedom to design the portion where the antenna is located. Furthermore, it is another objective of the invention to provide a wireless communication device equipped with the antenna.

(I) According to an aspect of the present invention, there is provided an antenna comprising: a ground conductor; and an antenna element portion for sending and receiving electromagnetic wave signals, the antenna element portion comprising: a coaxial cable including a center conductor and an outer conductor; a feeding point connected to a feeding system and disposed between the ground conductor and a first end of one of the center conductor and the outer conductor; a short-circuit portion that electrically connects the ground conductor and a first end of the other one of the center conductor and the outer conductor; and a conductor connection portion that electrically connects a second end of the center conductor and a second end of the outer conductor. In addition, an overall length of the coaxial cable is equal to or less than ½ of a wavelength that corresponds to the minimum series resonance frequency; and a distance between the center conductor and the outer conductor is equal to or less than 1/100 of a wavelength that corresponds to the minimum frequency of antenna operation.

(II) According to another aspect of the present invention, there is provided a wireless device that communicates information through electromagnetic wave signals, the wireless device being provided with an antenna comprising: a ground conductor; and an antenna element portion for sending and receiving the electromagnetic wave signals, the antenna element portion comprising: a coaxial cable including a center conductor and an outer conductor; a feeding point connected to a feeding system and disposed between the ground conductor and a first end of one of the center conductor and the outer conductor; a short-circuit portion that electrically connects the ground conductor and a first end of the other one of the center conductor and the outer conductor; and a conductor connection portion that electrically connects a second end of the center conductor and a second end of the outer conductor. Moreover, an overall length of the coaxial cable is equal to or less than ½ of a wavelength that corresponds to the minimum series resonance frequency; and a distance between the center conductor and the outer conductor is equal to or less than 1/100 of a wavelength that corresponds to the minimum frequency of antenna operation.

In the above aspects (I) and (II) of the invention, the following modifications and changes can be made.

i) The antenna element portion includes at least two antenna element portions; the at least two antenna element portions have the feeding point in common; and the at least two antenna element portions have the coaxial cables each of which has different dimensions from each other.

ii) The antenna further includes a conductor to be used as a second antenna element portion, the conductor being connected in parallel to the feeding point.

iii) The feeding point is fed with power by use of a feeding coaxial cable; and the coaxial cable of the antenna element portion and the feeding coaxial cable are formed with a single coaxial cable.

iv) The short-circuit portion comprises a conductive foil including an adhesive coating.

### Advantages of the Invention

According to the present invention, it is possible to provide a low-profile, small-sized, inexpensive antenna that is capable of operating at frequency bands equivalent to those at which conventional antennas are capable of operating and that extends the freedom to design the portion where the antenna is located. Also, it is possible to provide a wireless communication device equipped with the antenna.

### BRIEF DESCRIPTION OF THE DRAWINGS

FIG. 1A is a schematic configuration diagram showing an antenna in accordance with a first embodiment.

FIG. 1B is a schematic configuration diagram showing the antenna connected to a feeding coaxial cable.

FIG. 1C is a schematic diagram showing a plan view of the antenna of FIG. 1B.

FIG. 2 is a schematic diagram showing a cross-sectional view of an exemplary coaxial cable used in the antenna of FIGS. 1A to 10.

FIG. 3 shows an example of dimensions of the antenna in FIG. 10.

FIG. 4 is a graph showing a relationship between the frequency and the input admittance of the antenna of FIG. 3 as seen looking into the antenna from the feeding point.

FIG. 5 is a schematic diagram showing a plan view of an example of a conventional open stub antenna.

FIG. 6 is a graph showing a relationship between the frequency and the input admittance of the antenna of FIG. 5.

FIG. 7 is a schematic diagram showing a plan view of an example of a conventional short stub antenna.

FIG. 8 is a graph showing a relationship between the frequency and the input admittance of the antenna of FIG. 7.

FIG. 9 is a graph showing a relationship between the frequency and the return loss of the antenna of FIG. 3.

FIG. 10 is a graph showing a relationship between the frequency and the radiation efficiency of the antenna of FIG. 3.

FIG. 11 is a schematic configuration diagram showing one of advantages of the antenna in accordance with the first embodiment.

FIG. 12 is a schematic diagram showing a plan view of a variation of an antenna in accordance with the first embodiment.

FIG. 13A is a schematic configuration diagram showing an antenna in accordance with a second embodiment.

FIG. 13B is a schematic diagram showing a plan view of the antenna of FIG. 13A.

FIG. 14 is a schematic configuration diagram showing an antenna in accordance with a third embodiment.

FIG. 15A is a schematic configuration diagram showing an antenna in accordance with a fourth embodiment.

FIG. 15B is a schematic configuration diagram showing the antenna of FIG. 15A to which a feeding coaxial cable is connected.

FIG. 16 is a schematic configuration diagram showing an antenna in accordance with a fifth embodiment.

FIG. 17 is a schematic diagram showing a plane view of an example of a conventional planar multi-band antenna.

### DETAILED DESCRIPTION OF THE PREFERRED EMBODIMENTS

Preferred embodiments of the present invention will be described hereinafter with reference to the accompanying drawings. In the present specification, “electrically connect” means to connect such that the amount of the change in a ratio of voltage to current (impedance) of electrical signals at frequencies of interest is nearly zero at both ends to be connected.

### First Embodiment of the Invention

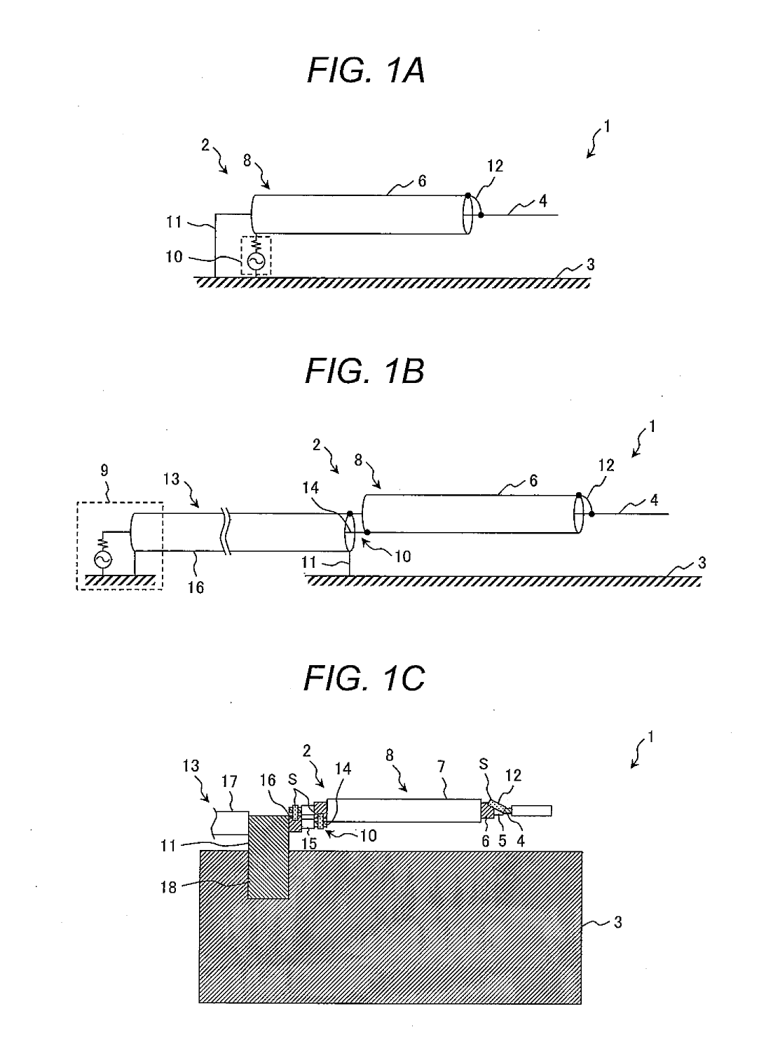

FIG. 1A is a schematic configuration diagram showing an antenna in accordance with a first embodiment; FIG. 1B is a schematic configuration diagram showing the antenna connected to a feeding coaxial cable; and FIG. 10 is a schematic diagram showing a plan view of the antenna of FIG. 1B.

As shown in FIGS. 1A through 1C, an antenna 1 is provided with an antenna element portion 2 that sends and receives electromagnetic wave signals and with a ground conductor 3. The antenna element portion 2 has: a coaxial cable 8 having a center conductor (core) 4 and an outer conductor 6; a feeding point 10 disposed between a first end of the outer conductor 6 and the ground conductor 3, and connected to a feeding system; a short-circuit portion 11 that electrically connects a first end of the center conductor 4 and the ground conductor 3; and a conductor connection portion 12 that electrically connects a second end of the center conductor 4 and a second end of the outer conductor 6. The overall length of the coaxial cable 8 is equal to or less than ½ of the wavelength that corresponds to the minimum series resonance frequency, and the distance between the center conductor 4 and the outer conductor 6 is equal to or less than 1/100 of the wavelength that corresponds to the minimum frequency of antenna operation.

Herein, the minimum frequency of antenna operation is the minimum frequency of electromagnetic wave signals that the antenna element portion 2 can send and receive, e.g., the minimum frequency included in a frequency band at which the return loss is lower than −6 dB. Also, the minimum series resonance frequency is the minimum frequency of frequencies at which the input conductance, which is the real component of the input admittance, is a local maximum value (series resonance frequencies).

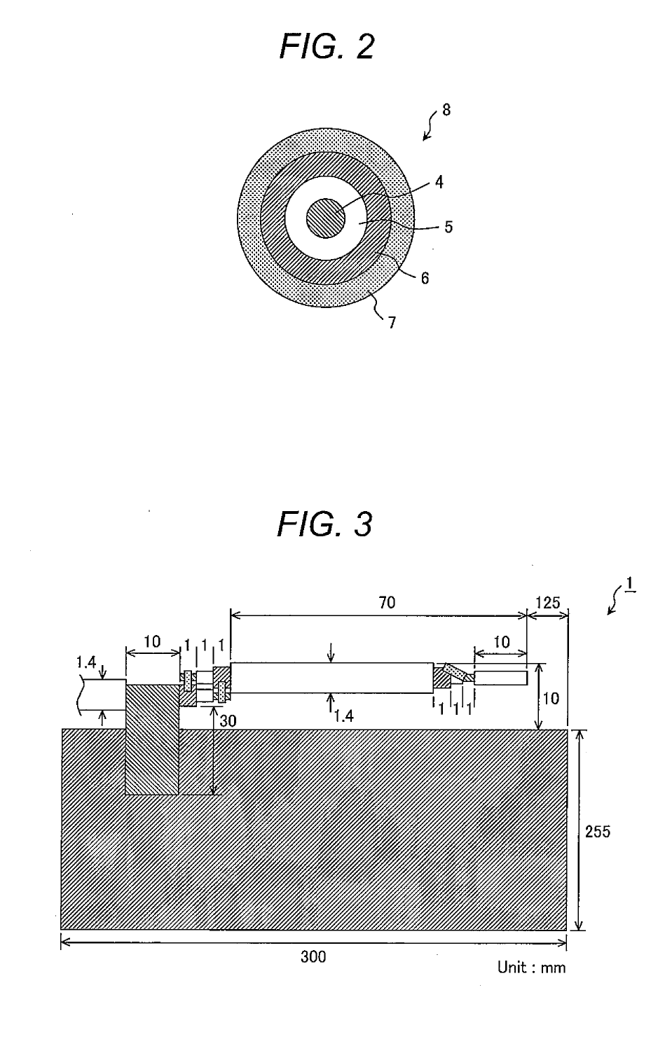

FIG. 2 is a schematic diagram showing a cross-sectional view of an exemplary coaxial cable used in the antenna of FIGS. 1A to 1C. The coaxial cable 8 is, as shown in FIGS. 1A-1C and 2, composed of an insulator 5, the outer conductor 6, and a jacket 7 that are sequentially formed around the center conductor 4. Both ends of the coaxial cable 8 are stripped in tiers such that the center conductor 4 is longer than the outer conductor 6. As described above, the distance between the center conductor 4 and the outer conductor 6 is equal to or less than 1/100 of the wavelength that corresponds to the minimum frequency of antenna operation. Herein, as the coaxial cable 8, a general-purpose thin coaxial cable having an outer diameter of several millimeters is used. Also, as described in detail hereinbelow, it is desirable that a highly flexible coaxial cable be used as the coaxial cable 8 in order to extend the freedom to design the portion where the antenna 1 is located.

In the antenna 1, the outer conductor 6 and a portion of the center conductor 4 outside of the outer conductor 6 operate as a radiating element. On the other hand, a portion of the center conductor 4 inside of the outer conductor 6 operates as an antenna matching circuit.

Generally, in order to increase the efficiency of an antenna in sending and receiving electromagnetic waves, it is necessary to obtain good matching conditions with a feeding system (a feeding coaxial cable 13 and a wireless communication module 9 described hereinbelow). In the antenna 1 in accordance with the present invention, experimental results have confirmed that the matching conditions with a feeding system are good around the series resonance frequencies in the input admittance. Also, the overall length of the coaxial cable 8 is approximately ¼ of the wavelength that corresponds to the minimum series resonance frequency in the input admittance and therefore it has been confirmed that the overall length of the coaxial cable 8 becomes less than ½ of the wavelength that corresponds to the minimum series resonance frequency in the input admittance. These will be described in detail hereinbelow.

In the antenna 1, the input admittance can be adjusted by varying as appropriate the dimensions of the coaxial cable 8, such as the distance between the coaxial cable 8 and the ground conductor 3 and the distance between the center conductor 4 and the outer conductor 6 of the coaxial cable 8 (a ratio of the diameter of the center conductor 4 to the diameter of the outer conductor 6). Thereby, good matching conditions with a feeding system can be obtained to allow the antenna 1 to operate at a desired frequency band.

Next, the reasons why the antenna 1 can be reduced in size will be described.

In conventional antennas composed of a conductor and a ground and fed with power between one point of the conductor and the ground, such as what is called an inverted L antenna or an open stub antenna, the difference between the lowest series resonance frequency and the second-lowest series resonance frequency is as large as several GHz in the input immittance frequency characteristics as seen from the feeding point. Such conventional antennas are capable of operating at frequency bands around series resonance frequencies, where matching conditions with a feeding system are relatively good, although there are cases where a matching circuit is required. Meanwhile, an inverted L antenna or an open stub antenna includes an open-end antenna element in which one end of the conductor is open.

In contrast, in the antenna 1 in accordance with the present invention, the difference between the lowest series resonance frequency fₒ′ and the second-lowest series resonance frequency fₒ″ is smaller than that of a conventional antenna in the input immittance frequency characteristics as seen from the feeding point 10. As is the case with a conventional antenna, the antenna 1 is capable of operating at frequency bands around the series resonance frequencies fₒ′ and fₒ″, where the matching conditions with a feeding system are relatively good. Also, the series resonance frequencies fₒ′ and fₒ″ depend on the dimensions of the coaxial cable 8 and the like (the distance between the center conductor 4 and the outer conductor 6, the position of the conductor connection portion 12, etc.) and are therefore adjustable.

In the antenna 1 in accordance with the present invention, by adjusting as appropriate the dimensions of the coaxial cable 8 and the like to select the values of the series resonance frequencies fₒ′ and fₒ″ as appropriate such that the frequency band around the series resonance frequency fₒ′ at which frequency band the antenna 1 is capable of operating (hereinafter referred to as “band of operation”) and the band of operation around the series resonance frequency fₒ″ overlap each other, a band of operation that is broader than that of a conventional antenna can be obtained. Experimental results have shown that the difference between the series resonance frequency fₒ′ and fₒ″ depends on the distance between the center conductor 4 and the outer conductor 6, and in order to obtain a broadband antenna, the distance between the center conductor 4 and the outer conductor 6 needs to be set at equal to or less than 1/100 of the wavelength that corresponds to the minimum frequency of antenna operation (details of which will be described hereinbelow).

Generally, the height of an antenna has a positive correlation with a frequency band at which the antenna is capable of operating. Therefore, if a frequency band of antenna operation becomes broader by means other than the height of the antenna, it is possible to secure a band of operation that is broad enough even if the height of the antenna is reduced, which permits the downsizing of an antenna.

In the present embodiment, as shown in FIGS. 1B and 1C, the feeding point 10 is fed with power via a feeding coaxial cable 13. The feeding coaxial cable 13 is composed of an insulator 15, an outer conductor 16, and a jacket 17 that are sequentially formed around a center conductor 14. As the feeding coaxial cable 13, the same dimensions coaxial cable as the coaxial cable 8 may be used, and another coaxial cable that is different from the coaxial cable 8 in dimensions or the like may be used.

A first end of the feeding coaxial cable 13 is connected to a wireless communication module 9 of a wireless device. A second end of the center conductor 14 of the feeding coaxial cable 13 is electrically connected to the first end of the outer conductor 6 of the coaxial cable 8, and a second end of the outer conductor 16 of the feeding coaxial cable 13 is electrically connected to the first end of the center conductor 4 of the coaxial cable 8, each by soldering for example. The symbol S in FIG. 1C denotes a soldered portion. As shown in FIG. 1C, in the present embodiment, the conductor connection portion 12 is the soldered portion S at which the center conductor 4 and the outer conductor 6 are connected with each other.

Also, in the present embodiment, a conductive foil (conductive tape) 18 having an adhesive coating is used as the short-circuit portion 11. In the antenna 1, the second end of the outer conductor 16 of the feeding coaxial cable 13 is connected to the ground conductor 3 using the conductor foil 18. More specifically, at the second end of the feeding coaxial cable 13, the jacket 17 is removed to expose the outer conductor 16, and to the exposed outer conductor 16 and the ground conductor 3 the conductor foil 18 having an adhesive coating on one side thereof is adhesively secured so that the outer conductor 16 of the feeding coaxial cable 13 and the ground conductor 3 are electrically connected.

As has been described above, in the antenna 1, the center conductor 4 of the coaxial cable 8 is electrically connected to the ground conductor 3 via the outer conductor 16 of the feeding coaxial cable 13 and the conductor foil 18 having an adhesive coating. However, the conductive foil 18 may be directly adhered to the center conductor 4 of the coaxial cable 8, thereby bypassing the outer conductor 16 of the feeding coaxial cable 13 and electrically connecting the center conductor 4 of the coaxial cable 8 to the ground conductor 3.

As the ground conductor 3, a part of an enclosure of a wireless device provided with the antenna 1, a ground portion of a printed-circuit board, or the like may be used. In such a case, the conductor foil 18 may be directly adhered to the conductor used as the ground conductor 3 (a part of the enclosure, the ground portion of a printed-circuit board, etc.).

Next, a relationship of the frequency characteristics of input immittance and series resonance frequencies to antenna configuration will be described in detail. Herein, for ease of illustration, the input admittance frequency characteristics of the antenna 1 in accordance with the present invention and the input admittance frequency characteristics of a conventional antenna will be compared.

FIG. 3 shows an example of dimensions of the antenna in FIG. 10. The dimensions are shown in unit of “mm” in FIG. 3. The antenna 1 in FIG. 3 was fabricated and the input admittance was measured. A mono-layer glass epoxy printed-circuit board (a glass epoxy board having a conductor pattern formed on one side thereof to be used as the ground conductor 3) was used as the ground conductor 3, and an aluminum tape was used as the conductor foil 18. Also, a coaxial cable whose center conductor 4, insulator 5, outer conductor 6, and jacket 7 were 0.3 mm, 0.9 mm, 1.1 mm, and 1.4 mm in outer diameter, respectively, was used as the coaxial cable 8. The distance between the center conductor 4 and the outer conductor 6 was 0.6 mm.

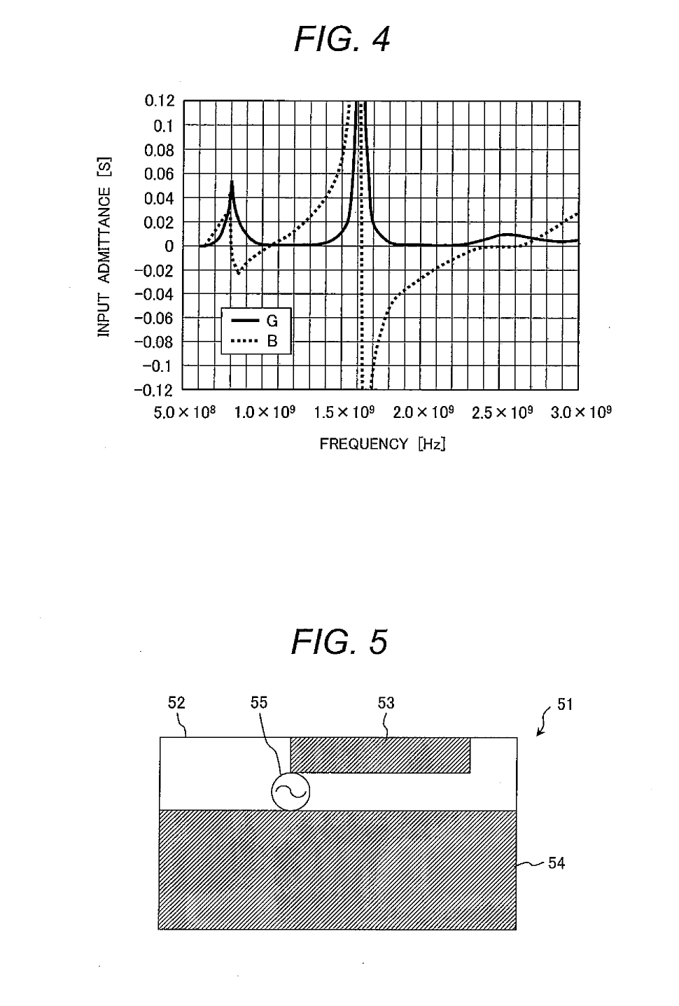

FIG. 4 is a graph showing a relationship between the frequency and the input admittance of the antenna of FIG. 3 as seen looking into the antenna from the feeding point. In FIG. 4, the solid line represents the conductance G, which is the real component of the input admittance, and the broken line represents the susceptance B, which is the imaginary component of the input admittance. In these input admittance frequency characteristics, frequencies at which the conductance G, which is the real component of the input admittance, is a local maximum value are series resonance frequencies.

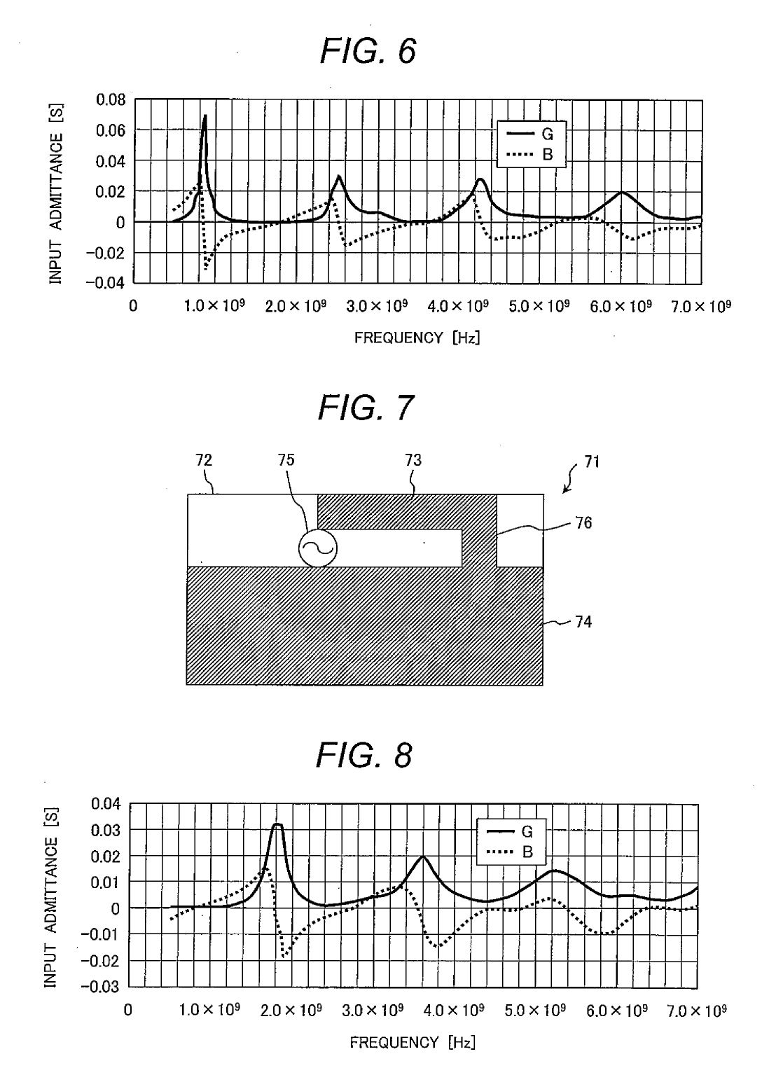

For comparison, FIG. 5 is a schematic diagram showing a plan view of an example of a conventional open stub antenna. FIG. 6 is a graph showing a relationship between the frequency and the input admittance of the antenna of FIG. 5. FIG. 7 is a schematic diagram showing a plan view of an example of a conventional short stub antenna. FIG. 8 is a graph showing a relationship between the frequency and the input admittance of the antenna of FIG. 7.

The open stub antenna 51 shown in FIG. 5 is composed of a rectangular conductor 53 (a conductor pattern that is rectangular in a plan view) formed on the surface of a printed-circuit board 52 and a ground conductor 54. A feeding point 55 is provided between the ground conductor 54 and a first end of the rectangular conductor 53, and a second end of the rectangular conductor 53 is open.

The short stub antenna 71 shown in FIG. 7 is composed of a rectangular conductor 73 (a conductor pattern that is rectangular in a plan view) formed on the surface of a printed-circuit board 72 and a ground conductor 74. A feeding point 75 is provided between the ground conductor 74 and a first end of the rectangular conductor 73, and a short-circuit portion 76 that short-circuits the rectangular conductor 73 and the ground conductor 74 is provided between the ground conductor 74 and a second end of the rectangular conductor 73. In other words, a short stub antenna includes a short-circuited-end antenna element in which both ends of the conductor are not open.

Generally, the characteristic impedance of an antenna system embedded in a communication terminal is “50+j₀ [Ω]”, and the characteristic admittance is its reciprocal, “0.02+j₀ [S]”. Therefore, when the input admittances of the antennas 1, 51 and 71 are “0.02+j₀ [S]”, these antennas are perfectly matched with a feeding system and can send and receive electromagnetic wave signals most efficiently.

As shown in FIGS. 4, 6 and 8, the antennas 1, 51 and 71, the conductance G is “0.02 [S]” around the series resonance frequencies (where the conductance G is a local maximum value). In FIGS. 4, 6 and 8, the susceptance B is not “0” at the frequencies where the conductance G is 0.02 [S]. However, the value of the susceptance B can be brought close to “0” by adding a matching circuit, thus making it possible to obtain good matching conditions with a feeding system. For example, the open stub antenna 51 may be changed to an inverted F antenna by adding a short-circuit line (short stub) in parallel to the open stub rectangular conductor 53 in order to adjust the susceptance B to “0” and obtain good matching conditions with a feeding system.

As has been described above, in the antennas 1, 51 and 71, the matching conditions with a feeding system are good around the series resonance frequencies, more specifically, around the frequencies where the conductance G is 0.02 [S].

As shown in FIG. 6, in the open stub antenna 51 shown in FIG. 5, the values of the series resonance frequencies are about 0.85 GHz, about 2.5 GHz, . . . in order from smallest to largest. Generally, in an open stub antenna, series resonance frequencies occur periodically with respect to frequencies, and series resonance frequencies except the minimum series resonance frequency are 3n times as high as the minimum series resonance frequency (n=1, 2, 3 . . . ). In the open stub antenna 51, the difference between the minimum series resonance frequency and the series resonance frequency adjacent thereto is about 1.65 GHz.

Also, as shown in FIG. 8, in the short stub antenna 71 shown in FIG. 7, the values of the series resonance frequencies are about 1.8 GHz, about 3.55 GHz, . . . in order from smallest to largest. Generally, in a short stub antenna, series resonance frequencies occur periodically with respect to frequencies, and series resonance frequencies except the minimum series resonance frequency are 2n times as high as the minimum series resonance frequency (n=1, 2, 3 . . . ). In the short stub antenna 71, the difference between the minimum series resonance frequency and the series resonance frequency adjacent thereto is about 1.75 GHz.

In contrast, in the antenna 1 in accordance with the first embodiment, as shown in FIG. 4, the values of the series resonance frequencies are about 800 MHz, about 1.6 GHz, . . . in order from smallest to largest. Unlike the open stub antenna 51 and the short stub antenna 71 mentioned above, the difference between the minimum series resonance frequency and the series resonance frequency adjacent thereto is as small as about 800 MHz. As just described, in the antenna 1, the difference between the minimum series resonance frequency (hereinafter referred to as “the first series resonance frequency”) and the second-lowest series resonance frequency (hereinafter referred to as “the second series resonance frequency”) is small as compared to the open stub antenna 51 and the short stub antenna 71.

In addition, although not shown in FIG. 4, more detailed study of the input admittance frequency characteristics of the antenna 1 has revealed that the series resonance frequencies occur at frequencies that are 3n times as high as the first series resonance frequency and at frequencies that are 2n times as high as the second series resonance frequency. In other words, it can be said that in the antenna 1, the antenna element portion 2 has the combined features of a short stub antenna and an open stub antenna, resulting in a small difference between the first series resonance frequency and the second resonance frequency.

Experimental results have shown that the operation of the antenna 1 as an open stub antenna (i.e. the first series resonance frequency) is affected by the length from the feeding point 10 to the second end of the center conductor 4 (the length of the longer one of the two conductors 4 and 6), and its operation as a short stub antenna (i.e. the second series resonance frequency) is affected by the length from the feeding point 10 to the conductor connection portion 12 (the soldered portion S). Therefore, the difference between the first series resonance frequency and the second series resonance frequency can be adjusted by adjusting these lengths as appropriate. Since a change in the length of the center conductor 4 (the length of the longer one of the two conductors 4 and 6) means a change in a band of operation, the difference between the first series resonance frequency and the second series resonance frequency is preferably adjusted by adjusting the position of the conductor connection portion 12.

As has been described above, in the antenna 1 in accordance with the first embodiment, the two series resonance frequencies (the first and second series resonance frequencies) can be arranged within a narrower frequency band, and by adjusting the distance between these series resonance frequencies as appropriate, two frequency bands at which matching conditions are good can be brought closer to each other so that they become one broader frequency band at which matching conditions are good.

Also, as described above, the minimum series resonance frequency of the antenna 1 is approximately 800 MHz, at which ½ of a wavelength is approximately 187 mm. As shown in FIG. 3, the overall length of the coaxial cable 8 is 73 mm, which is less than ½ of the wavelength that corresponds to the minimum series resonance frequency.

In addition, as described above, in the antenna 1, the matching conditions with a feeding system are good around the minimum series resonance frequency, the antenna 1 is capable of operating at frequencies lower than about 800 MHz, which is the minimum series resonance frequency. In other words, the wavelength that corresponds to the minimum frequency of antenna operation is at least higher than 374 mm. The distance between the center conductor 4 and the outer conductor 6 is 0.6 mm, which means that the distance between the center conductor 4 and the outer conductor 6 is less than 1/100 of the wavelength that corresponds to the minimum frequency of antenna operation.

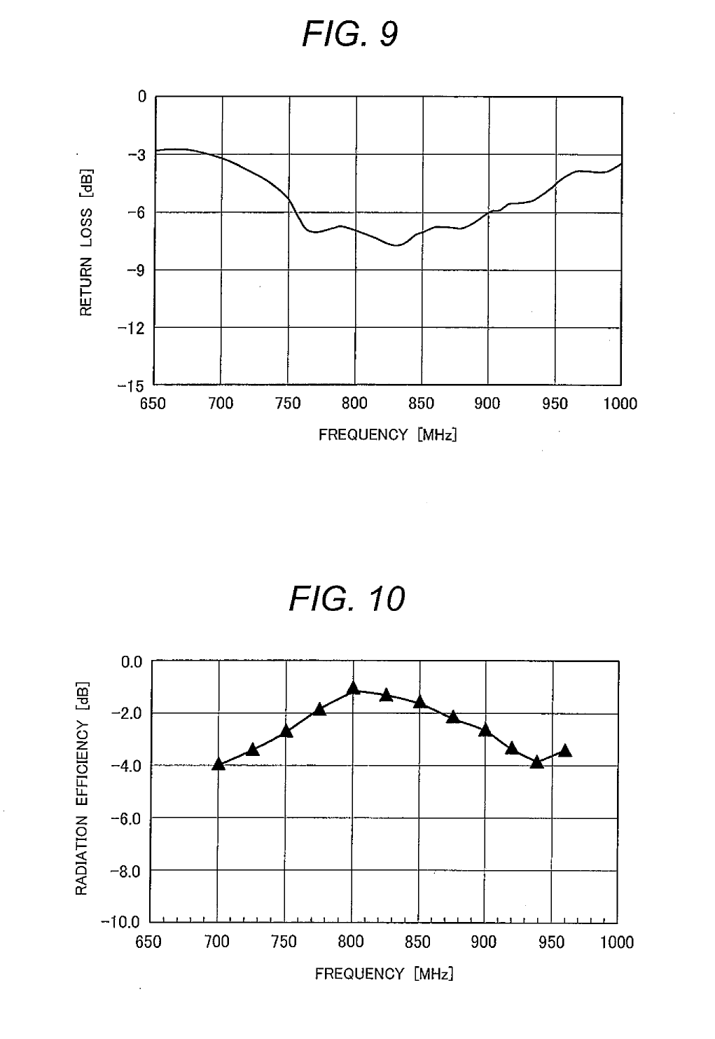

Furthermore, the return loss and the radiation efficiency of the antenna 1 having the dimensions shown in FIG. 3 were measured. FIG. 9 is a graph showing a relationship between the frequency and the return loss of the antenna of FIG. 3; and FIG. 10 is a graph showing a relationship between the frequency and the radiation efficiency of the antenna of FIG. 3.

As shown in FIG. 9, in the antenna 1 fabricated, the frequency bandwidth having a return loss smaller than −6 dB is approximately 140 MHz (from about 760 MHz to about 900 MHz), indicating that the matching conditions with a feeding system are good in this bandwidth. Moreover, FIG. 10 shows that the radiation efficiency is equal to or more than −3 dB at frequencies of about 750 MHz to 900 MHz, indicating the antenna 1 is capable of operating at a frequency band around them.

Next, the operation of the first embodiment will be described.

As described before, in the antenna 1 in accordance with the first embodiment, the antenna element portion 2 is composed of the coaxial cable 8 having the center conductor 4 and the outer conductor 6; the feeding point 10 disposed between the ground conductor 3 and the first end of the outer conductor 6 and connected to a feeding system; the short-circuit portion 11 that electrically connects the ground conductor 3 and the first end of the center conductor 4; and the conductor connection portion 12 that electrically connects the second end of the center conductor 4 and the second end of the outer conductor 6. The overall length of the coaxial cable 8 is equal to or less than ½ of the wavelength that corresponds to the minimum series resonance frequency, and the distance between the center conductor 4 and the outer conductor 6 is equal to or less than 1/100 of the wavelength that corresponds to the minimum frequency of antenna operation.

This configuration permits the antenna element portion 2 to have the combined features of a short stub antenna and an open stub antenna, which makes it possible to obtain a broader band of operation than that of a conventional antenna by overlapping a band of operation around the minimum series resonance frequency (the first series resonance frequency) and a band of operation around the second-lowest series resonance frequency (the second series resonance frequency). In other words, according to the present invention, the antenna 1 has a broader band of operation than that of a conventional antenna of the same size.

Therefore, even if the band of operation is reduced as a result of reducing the height of the antenna 1 by bringing the coaxial cable 8 (the center conductor 4 and the outer conductor 6) closer to the ground conductor 3, a band of operation that is comparable to that of a conventional antenna can be secured, which makes it possible to obtain the antenna 1 that is low-profile, small in size, and capable of operating at frequency bands equivalent to those at which conventional antennas are capable of operating.

Thus, according to the present invention, the antenna 1 is smaller in size than conventional antennas. More specifically, it is possible to reduce the height of the antenna, namely, the distance between the top end of the ground conductor 3 and the top most end of the antenna element portion 2 that is the farthest away from the ground conductor 3. As has been described above, when embedded in a wireless device, generally, the antenna is disposed near the wall of the enclosure of the device in order to maintain good antenna characteristics. Therefore, the low-profile, small-sized antenna 1 in accordance with the present invention can be easily mounted in a housing of a wireless device and reduce the projections and depressions in the outer shape of the housing, which makes it possible to obtain a wireless device that is smaller in size.

Moreover, because the antenna element portion 2 of the antenna 1 can be made of a general-purpose coaxial cable, the antenna 1 is inexpensive as compared to conventional antennas.

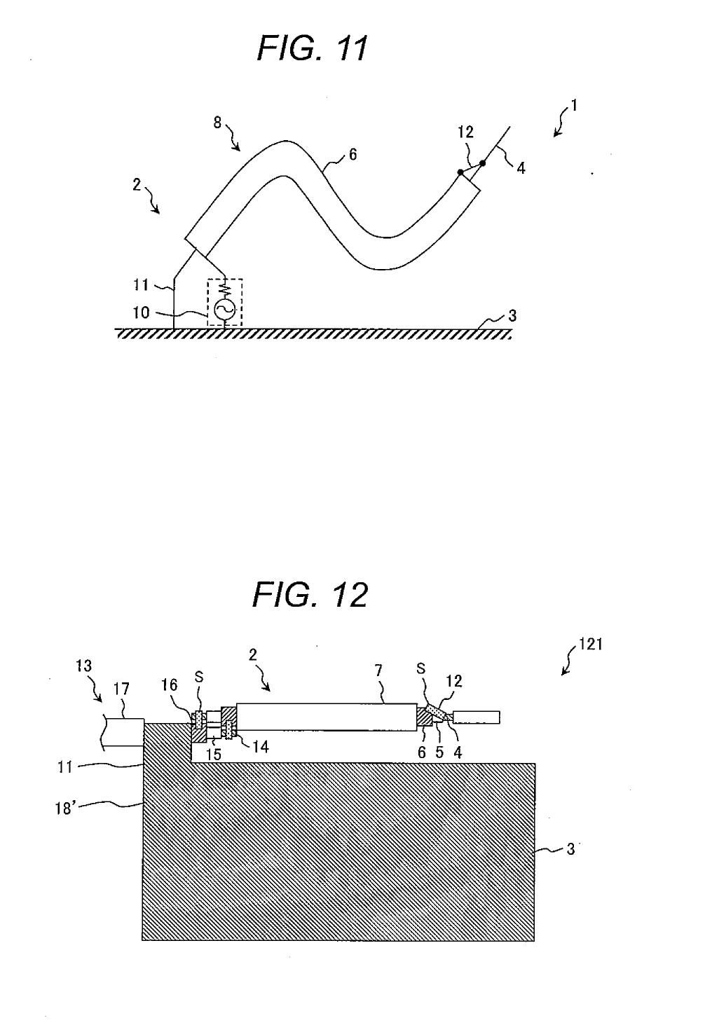

FIG. 11 is a schematic configuration diagram showing one of advantages of the antenna in accordance with the first embodiment. As shown in FIG. 11, the antenna element portion 2 is flexible because the antenna element portion 2 of the antenna 1 is a general-purpose coaxial cable, and therefore the antenna 1 can be located in a space having a complex shape. This extends the freedom to design the portion where the antenna 1 is located in a wireless device.

In short, according to the present invention, there can be obtained an inexpensive antenna that is capable of operating at frequency bands equivalent to those at which conventional antennas are capable of operating, extends the freedom to design the portion where the antenna is located, and can be mounted on laptop personal computers, UMPCs, netbooks, cellular phones, PNDs, sensor network terminals, electronic book readers, or the like.

### Alternative Variation of the First Embodiment

FIG. 12 is a schematic diagram showing a plan view of a variation of an antenna in accordance with the first embodiment. As shown in FIG. 12, in an antenna 121, a conductor foil 18′, of which the short-circuit portion 11 is formed, has been enlarged to form the shape of an L, and a part of the conductor foil 18′ is used as the ground conductor 3.

In the antenna 1 shown in FIG. 10, another conductor separate from the antenna element portion 2 is required as the ground conductor 3. However, when there is no conductor to be used as the ground conductor 3 near the portion where the antenna 1 is located (e.g., a part of the enclosure of a wireless device, the ground portion of a printed-circuit board, etc.), it is difficult to obtain a desired impedance, resulting in degraded matching conditions with a feeding system and in a decline in antenna performance.

In the antenna 121, the L-shaped conductor foil 18′ having appropriate dimensions works as the ground conductor 3. Therefore, even when there is no conductor that can be used as the ground conductor 3 near the portion where the antenna 121 is located, a desired impedance can be obtained and the matching conditions between the antenna 121 and a feeding system can be improved.

### Second Embodiment of the Invention

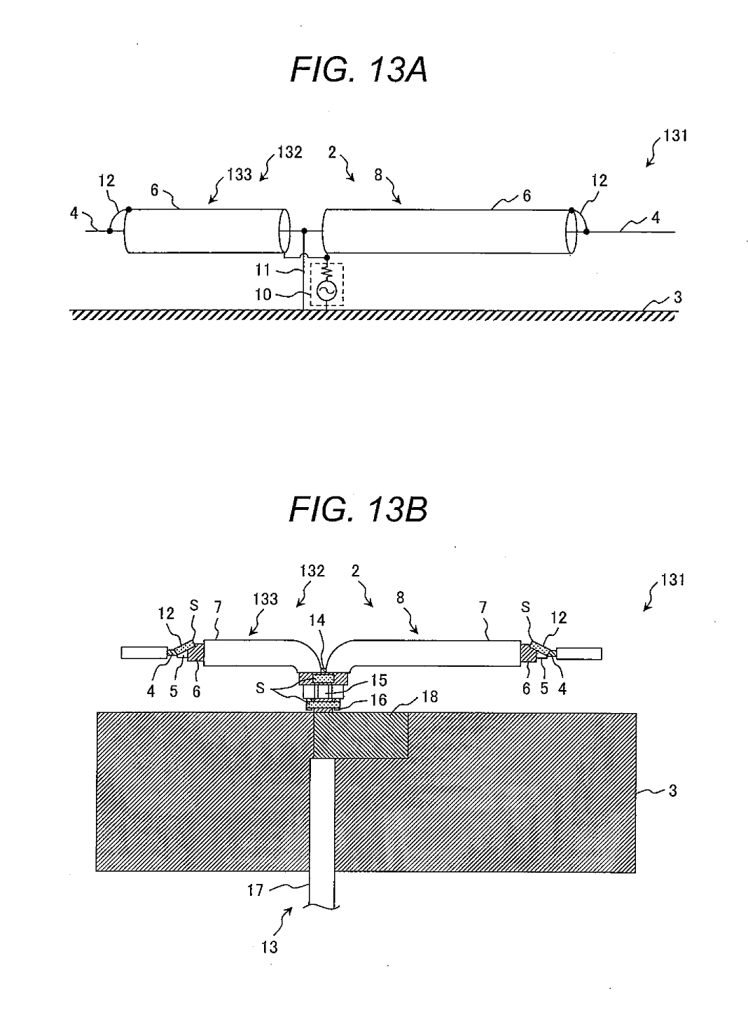

Next, a second embodiment of the present invention will be described with reference to FIGS. 13A and 13B. FIG. 13A is a schematic configuration diagram showing an antenna in accordance with a second embodiment; and FIG. 13B is a schematic diagram showing a plan view of the antenna of FIG. 13A.

As shown in FIGS. 13A and 13B, an antenna 131 is composed of the antenna shown in FIGS. 1A and 1C and another antenna element portion 132 connected in parallel in addition to the antenna element portion 2. The antenna element portion 132 has a coaxial cable 133 having dimensions different from those of the coaxial cable 8 (the center conductor 4 and the outer conductor 6) of the antenna element portion 2.

The two antenna element portions 2 and 132 are provided with the feeding point 10 and the short-circuit portion 11 in common. In other words, the two antenna element portions 2 and 132 are connected in parallel with respect to the feeding point 10.

Herein, as the coaxial cable 133 of the antenna element portion 132, the same kind coaxial cable as the coaxial cable 8 of the antenna element portion 2 is used, and the coaxial cable 133 is shorter than the coaxial cable 8. The center conductors 4 of the coaxial cables 8 and 133 are electrically connected to the outer conductor 16 of the feeding coaxial cable 13 by soldering, and the outer conductors 6 of the coaxial cables 8 and 133 are electrically connected to the center conductor 14 of the feeding conductor cable 13 by soldering. Also, the second ends of the center conductor 4 and the outer conductor 6 of the coaxial cable 133 are electrically connected to each other by soldering to form a conductor connection portion 12.

In the antenna 131, the coaxial cable 13 of the antenna element portion 132 is shorter than the coaxial cable 8 of the antenna element portion 2, and so the center conductor 4 and the outer conductors 6 of the coaxial cable 133 and those of the coaxial cable 8 are different in length (dimensions). As a result, the band of operation of the antenna element portion 2 and that of the antenna element portions 132 are different, which permits the antenna 131 to operate at a plurality of bands and therefore in a plurality of systems.

On the other hand, by selecting the lengths of the coaxial cables 8 and 133 such that the two antenna element portions 2 and 132 operate at frequency bands that are appropriately close to each other, the bands of operation of the two antenna element portions 2 and 132 can be overlapped, thereby making the antenna 131 capable of operating at a broader frequency band.

Herein, although the case where the two antenna element portions 2 and 132 are connected in parallel has been described, three or more antenna element portions may be connected in parallel to permit antenna operation at more frequency bands (or a wider frequency band) to obtain an antenna that is capable of operating in even more systems.

### Third Embodiment of the Invention

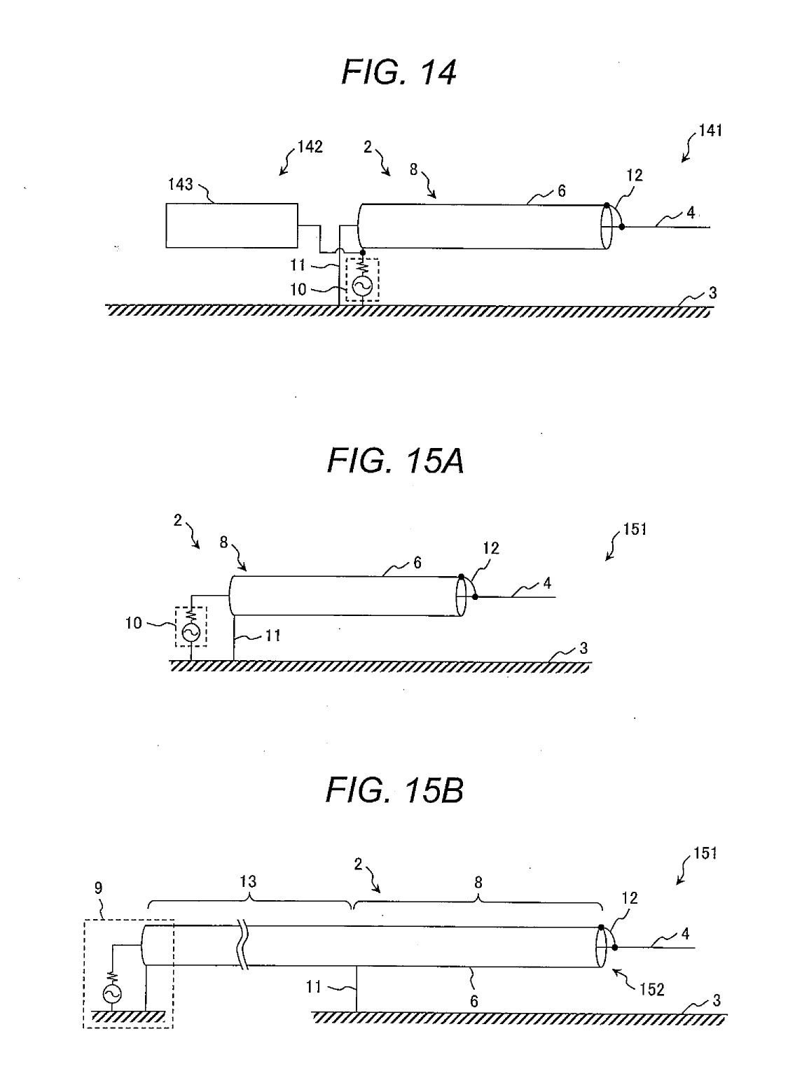

Next, a third embodiment of the present invention will be described with reference to FIG. 14. FIG. 14 is a schematic configuration diagram showing an antenna in accordance with a third embodiment.

As shown in FIG. 14, an antenna 141 is composed of the antenna shown in FIG. 1A and a conductor 143 as a second antenna element portion 142 connected in parallel to the feeding point 10.

Herein, a conductor plate that is rectangular in a plan view is used as the conductor 143. However, a conductor pattern formed on a printed-circuit board may be used instead. A first end of the conductor 143 is electrically connected to the portion where the outer conductor 6 and the feeding point 10 are electrically connected to each other, and a second end of the conductor 143 is open.

In the antenna 141, the second antenna element portion 142 operates as an open stub antenna. Herein, although the conductor 143 is an open-end conductor in FIG. 14, it may be a short-circuited-end conductor. Also, a short-circuit line may be provided that electrically connects the conductor 143 and the ground conductor 3 in order to improve the matching conditions with a feeding system.

In the antenna 141, the second antenna element portion 142 can be made capable of operating at a frequency band that is different from the frequency band at which the antenna element portion 2 is capable of operating by selecting the dimensions of the conductor 143 as appropriate, which permits antenna operation at a plurality of frequency bands. Therefore, as with the second embodiment described above, the antenna 141 thus obtained is an antenna that is capable of operating in a plurality of systems. Also, by configuring the antenna 141 such that the two antenna element portions 2 and 142 operate at frequency bands that are appropriately close to each other, the antenna 141 can be made capable of operating at a broader frequency band.

Moreover, there can be obtained an antenna that is capable of operating at more frequency bands (or at a broader frequency band) and therefore in even more systems by connecting a plurality of conductors in parallel.

### Fourth Embodiment of the Invention

Next, a fourth embodiment of the present invention will be described with reference to FIGS. 15A and 15B. FIG. 15A is a schematic configuration diagram showing an antenna in accordance with a fourth embodiment; and FIG. 15B is a schematic configuration diagram showing the antenna of FIG. 15A to which a feeding coaxial cable is connected.

As shown in FIG. 15A, an antenna 151 is the same as the antenna 1 shown in FIG. 1A except that power is fed between the ground conductor 3 and the first end of the center conductor 4, and that the first end of the outer conductor 6 and the ground conductor 3 are electrically connected. In other words, the antenna 151 is different from the antenna 1 in that the positions of the feeding point 10 and the short-circuit portion 11 have been switched.

The antenna 151 can produce the same effects as those produced by the first embodiment described before. Furthermore, the coaxial cable 8 of the antenna element portion 2 and the feeding coaxial cable 13 can be formed with one common coaxial cable.

More specifically, as shown in FIG. 15B, a first end of a common coaxial cable 152 is connected to the wireless communication module 9 of a wireless device, and second ends of the center conductor 4 and the outer conductor 6 of the coaxial cable 152 are electrically connected to each other to form the conductor connection portion 12. Also, a jacket of the coaxial cable 152 is removed at some point along the coaxial cable 152 to expose the outer conductor 6, which is connected to the ground conductor 3 by use of a conductor (e.g., the conductor foil 18) to form the short-circuit portion 11. In this configuration, the portion of the coaxial cable 152 from the short-circuit portion 11 toward its second end operates as the coaxial cable 8 of the antenna element portion 2, and the portion of the coaxial cable 152 from the short-circuit portion 11 toward its first end operates as the feeding cable 13.

Forming the coaxial cable 8 of the antenna element portion 2 and the feeding coaxial cable 13 with the common coaxial cable 152 saves the trouble of connecting the feeding cable 13, which makes it possible to further reduce the cost of an antenna.

### Fifth Embodiment of the Invention

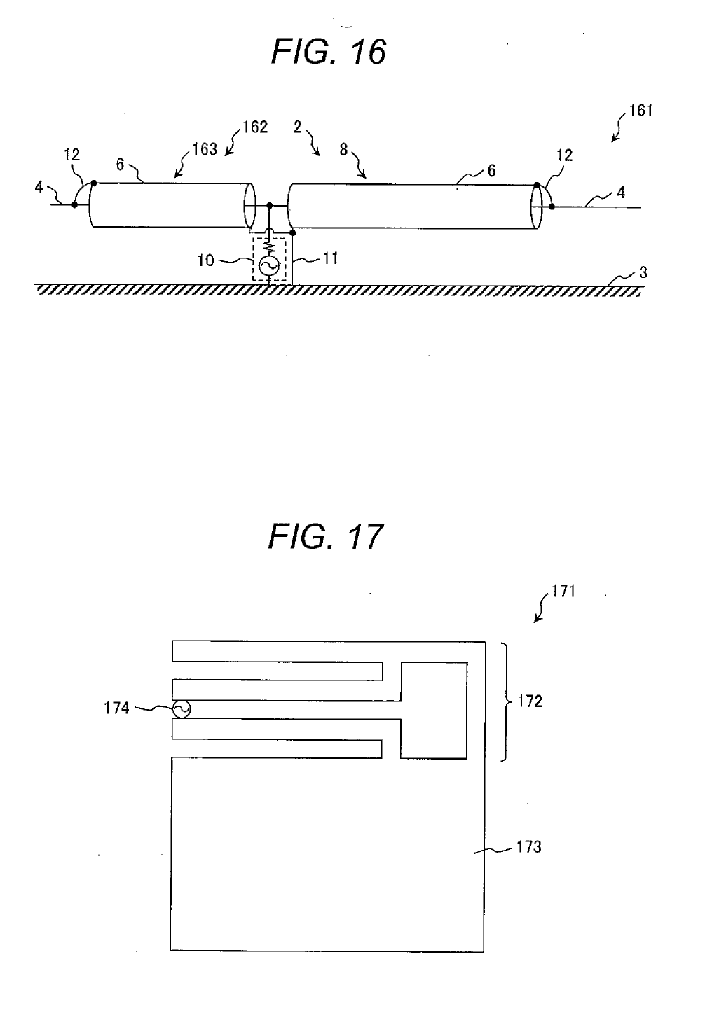

Next, a fifth embodiment of the present invention will be described with reference to FIG. 16. FIG. 16 is a schematic configuration diagram showing an antenna in accordance with a fifth embodiment.

As shown in FIG. 16, an antenna 161 is composed of the antenna shown in FIG. 15A and another antenna element portion 162 connected in parallel in addition to the antenna element portion 2. The antenna element portion 162 has a coaxial cable 163 having dimensions different from those of the coaxial cable 8 (the center conductor 4 and the outer conductor 6) of the antenna element portion 2. Although FIG. 16 shows the two antenna element portions 2 and 162 connected in parallel, it should be understood, of course, that three or more antenna element portions may be connected in parallel.

As with the second embodiment described before, the antenna 161 thus obtained is an antenna that is capable of operating at more frequency bands and in more systems. Also, the antenna 161 can be made capable of operating at a broader frequency band by configuring the antenna 161 such that the two antenna element portions 2 and 162 operate at frequency bands that are appropriately close to each other.

It should be appreciated, of course, that the present invention is not to be construed as limited to the embodiments above, and various changes may be made without departing from the spirit and scope of the present invention. For example, although in the above embodiments, the feeding point 10 is fed with power by use of the feeding coaxial cable 13, it may be fed with power by use of a transmission line formed on a printed-circuit board, such as a microstrip line path. In addition, although not mentioned in the above embodiments, it should be understood, of course, that a short-circuit line that electrically connects the outer conductor 6 of the coaxial cable 8 and the ground conductor 3 may be provided in order to improve the matching conditions with a feeding system.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An antenna comprising:
a ground conductor; and
an antenna element portion for sending and receiving electromagnetic wave signals, the antenna element portion comprising:
a coaxial cable including a center conductor and an outer conductor;
a feeding point connected to a feeding system and disposed between the ground conductor and a first end of one of the center conductor and the outer conductor;
a short-circuit portion that electrically connects the ground conductor and a first end of the other one of the center conductor and the outer conductor; and
a conductor connection portion that electrically connects a second end of the center conductor and a second end of the outer conductor, wherein:
an overall length of the coaxial cable is equal to or less than ½ of a wavelength corresponding to the minimum series resonance frequency; and
a distance between the center conductor and the outer conductor is equal to or less than 1/100 of a wavelength corresponding to the minimum frequency of antenna operation.

2. The antenna according to claim 1, wherein:
the antenna element portion comprises at least two antenna element portions;
the at least two antenna element portions have the feeding point in common; and
the at least two antenna element portions have the coaxial cables each of which has different dimensions from each other.

3. The antenna according to claim 1, further comprising: a conductor to be used as a second antenna element portion, the conductor being connected in parallel to the feeding point.

4. The antenna according to claim 1, wherein:
the feeding point is fed with power by use of a feeding coaxial cable; and
the coaxial cable of the antenna element portion and the feeding coaxial cable are formed with a single coaxial cable.

5. The antenna according to claim 1, wherein the short-circuit portion comprises a conductive foil including an adhesive coating.

6. A wireless device that communicates information through electromagnetic wave signals, the wireless device being provided with an antenna comprising:
a ground conductor; and
an antenna element portion for sending and receiving the electromagnetic wave signals, the antenna element portion comprising:
a coaxial cable including a center conductor and an outer conductor;
a feeding point connected to a feeding system and disposed between the ground conductor and a first end of one of the center conductor and the outer conductor;
a short-circuit portion that electrically connects the ground conductor and a first end of the other one of the center conductor and the outer conductor; and
a conductor connection portion that electrically connects a second end of the center conductor and a second end of the outer conductor, wherein:
an overall length of the coaxial cable is equal to or less than ½ of a wavelength corresponding to the minimum series resonance frequency; and
a distance between the center conductor and the outer conductor is equal to or less than 1/100 of a wavelength corresponding to the minimum frequency of antenna operation.

7. The wireless device according to claim 6, wherein:
the antenna element portion comprises at least two antenna element portions;
the at least two antenna element portions have the feeding point in common; and
the at least two antenna element portions have the coaxial cables each of which has different dimensions from each other.

8. The wireless device according to claim 6, further comprising: a conductor to be used as a second antenna element portion, the conductor being connected in parallel to the feeding point.

9. The wireless device according to claim 6, wherein:
the feeding point is fed with power by use of a feeding coaxial cable; and
the coaxial cable of the antenna element portion and the feeding coaxial cable are formed with a single coaxial cable.

10. The wireless device according to claim 6, wherein the short-circuit portion comprises a conductive foil including an adhesive coating.
